(19) United States
(12) Patent Application Publication
(10) Pub. No.: US 2010/0056620 A1
(43) Pub. Date: Mar. 4, 2010

(54) ACTIVE COMPOUND COMBINATIONS WITH INSECTICIDAL AND ACARICIDAL PROPERTIES

(75) Inventors: Reiner Fischer, Monheim (DE); Heike Hungenberg, Laugenfeld (DE); Ralf Nauen, Langenfeld (DE); Emmanuel Salmon, Koln (DE); Hans-jurgen Schnorbach, Monheim (DE); Wolfgang Thielert, Odenthal (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/304,958

(22) PCT Filed: Jun. 5, 2007
(86) PCT No.: PCT/EP07/04971

§ 371 Date: Aug. 26, 2009

(30) Foreign Application Priority Data
Jun. 16, 2006 (DE) 10 2006 027 730.9

(51) Int. Cl. A01N 43/08; A01P 7/00

(52) U.S. Cl. 514/462

(57) ABSTRACT

The novel active compound combinations consisting, firstly, of cyclic ketoenols and, secondly, of beneficial species (natural enemies) have very good insecticidal and/or acaricidal properties.

The present invention relates to novel active compound combinations consisting, firstly, of known cyclic ketoenols and, secondly, of beneficial species (natural enemies), which combinations are highly suitable for controlling animal pests such as insects and/or unwanted acarids.

It is already known that certain cyclic ketoenols have insecticidal and acaricidal properties (EP-A-528 156). WO 95/01971, EP-A-647 637, WO 96/16061, WO 96/20196, WO 96/25395, WO 96/35664, WO 97/02243, WO 97/01535, WO 97/36868, WO 97/43275, WO 98/05638, WO 98/06721, WO 99/16748, WO 99/43649, WO 99/48869, WO 99/55673, WO 00/42850, WO 01/17972, WO 01/23354, WO 01/74770, WO 03/013249, WO 04/024688, WO 04/080962, WO 04/111042, WO 05/092897, WO 06/000355, WO 06/002824 and WO 06/029799 describe further ketoenols having insecticidal and/or acaricidal properties. The activity of these substances is good; however, at low application rates it is sometimes unsatisfactory.

It is furthermore already known that numerous beneficial species are used for controlling insects and spider mites: “Knowing and recognizing”; M. H. Malais, W. J. Ravensberg, published by Koppert B. V., Reed Business Information (2003). However, the use of beneficial species on their own is not always satisfactory.

It has now been found that compounds of the formula (I)

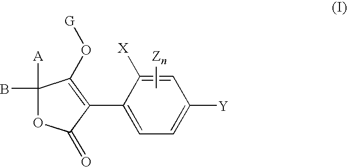

in which
X represents C₁-C₆-alkyl, halogen, C₁-C₆-alkoxy or C₁-C₃-haloalkyl,
Y represents hydrogen, C₁-C₆-alkyl, halogen, C₁-C₆-alkoxy or C₁-C₃-haloalkyl,
Z represents C₁-C₆-alkyl, halogen or C₁-C₆-alkoxy,
n represents a number 0-3,
A represents hydrogen or in each case optionally halogen-substituted straight-chain or branched C₁-C₁₂-alkyl, C₃-C₈-alkenyl, C₃-C₈-alkynyl, C₁-C₁₀-alkoxy-C₂-C₈-alkyl, C₁-C₈-polyalkoxy-C₂-C₈-alkyl, C₁-C₁₀-alkylthio-C₂-C₈-alkyl or cycloalkyl having 3-8 ring atoms which may be interrupted by oxygen and/or sulphur and in each case optionally halogen-, C₁-C₆-alkyl-, C₁-C₆-haloalkyl-, C₁-C₆-alkoxy-, C₁-C₆-haloalkoxy- or nitro-substituted phenyl or phenyl-C₁-C₆-alkyl,
B represents hydrogen, C₁-C₆-alkyl or C₁-C₆-alkoxy-C₂-C₄-alkyl
   or in which
A and B together with the carbon atom to which they are attached form a saturated or unsaturated 3- to 8-membered ring which is optionally interrupted by oxygen and/or sulphur and optionally substituted by halogen, C₁-C₆-alkyl, C₁-C₆-alkoxy, C₁-C₄-haloalkyl, C₁-C₄-haloalkoxy, C₁-C₄-alkylthio or optionally substituted phenyl or is optionally benzo-fused,
G represents hydrogen (a) or represents the groups

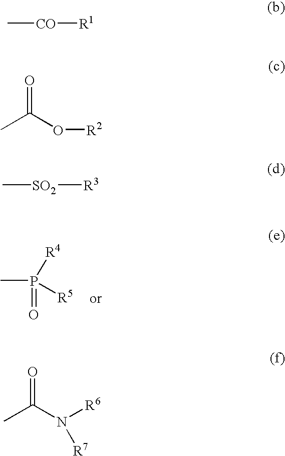

in which
R¹ represents in each case optionally halogen-substituted C₁-C₂₀-alkyl, C₂-C₂₀-alkenyl, C₁-C₈-alkoxy-C₂-C₈-alkyl, C₁-C₈-alkylthio-C₂-C₈-alkyl, C₁-C₈-polyalkoxy-C₂-C₈-alkyl or cycloalkyl having 3-8 ring atoms which may be interrupted by oxygen and/or sulphur atoms,
   represents optionally halogen-, nitro-, C₁-C₆-alkyl-, C₁-C₆-alkoxy-, C₁-C₆-haloalkyl- or C₁-C₆-haloalkoxy-substituted phenyl,
   represents optionally halogen-, C₁-C₆-alkyl-, C₁-C₆-alkoxy-, C₁-C₆-haloalkyl- or C₁-C₆-haloalkoxy-substituted phenyl-C₁-C₆-alkyl,
   represents in each case optionally halogen- and/or C₁-C₆-alkyl-substituted pyridyl, pyrimidyl, thiazolyl or pyrazolyl,
   represents optionally halogen- and/or C₁-C₆-alkyl-substituted phenoxy-C₁-C₆-alkyl,
R² represents in each case optionally halogen-substituted C₁-C₂₀-alkyl, C₂-C₂₀-alkenyl, C₁-C₈-alkoxy-C₂-C₈-alkyl or C₁-C₈-polyalkoxy-C₂-C₈-alkyl,
   represents in each case optionally halogen-, nitro-, C₁-C₆-alkyl-, C₁-C₆-alkoxy- or C₁-C₆-haloalkyl-substituted phenyl or benzyl,
R³ represents optionally halogen-substituted C₁-C₈-alkyl, represents in each case optionally C₁-C₄-alkyl-, halogen-, C₁-C₄-haloalkyl-, C₁-C₄-alkoxy-, C₁-C₄-haloalkoxy-, nitro- or cyano-substituted phenyl or benzyl,
R⁴ and R⁵ independently of one another represent in each case optionally halogen-substituted C₁-C₈-alkyl, C₁-C₈-alkoxy, C₁-C₈-alkylamino, di-(C₁-C₈)-alkylamino, C₁-C₈-alkylthio, C₂-C₅-alkenylthio, C₂-C₅-alkynylthio or C₃-C₇-cycloalkylthio, represent in each case optionally halogen-, nitro-, cyano-, C₁-C₄-alkoxy-, C₁-C₄-haloalkoxy-, C₁-C₄-alkylthio-, C₁-C₄-haloalkylthio-, C₁-C₄-alkyl- or C₁-C₄-haloalkyl-substituted phenyl, phenoxy or phenylthio,
R⁶ and R⁷ independently of one another represent in each case optionally halogen-substituted C₁-C₁₀-alkyl, C₁-C₁₀-alkoxy, C₃-C₈-alkenyl or C₁-C₈-alkoxy-C₁-C₈-alkyl, represent optionally halogen-, C₁-C₆-haloalkyl-, C₁-C₆-alkyl- or C₁-C₆-alkoxy-substituted phenyl, represent optionally halogen-, C₁-C₆-alkyl-, C₁-C₆-haloalkyl- or C₁-C₆-alkoxy-substituted benzyl or together represent a 5- to 6-membered ring which is optionally interrupted by oxygen or sulphur and which may optionally be substituted by C₁-C₆-alkyl,
   in combination with beneficial species from the orders or sub-orders of the Araneae, Acari, Hymenoptera, Coleoptera, Neuroptera, Tysanoptera, Heteroptera, Diptera, Hemiptera, Dermaptera and Parasitiformes have very good insecticidal and/or acaricidal properties.

Surprisingly, the insecticidal and/or acaricidal activity of the active compound/beneficial species combinations according to the invention is better than the activities of the individual active compound and the beneficial species alone. An unforeseeable enhancement of activity is present.

Furthermore, it has been found that, using the active compound/beneficial species combinations according to the invention, applications of toxicologically and/or ecologically less favourable active compounds may be substituted achieving a comparable activity, which is beneficial especially with respect to safety of the user and/or the environment. Moreover, it has been found that spray applications may be reduced. In addition to at least one active compound of the formula (I), the active compound/beneficial species combinations according to the invention comprise at least one beneficial species from the orders or sub-orders mentioned above.

Preference is given to using active compound/beneficial species combinations comprising compounds of the formula (I) in which the radicals are as defined below:
X preferably represents C₁-C₄-alkyl, halogen, C₁-C₄-alkoxy or C₁-C₂-haloalkyl,
Y preferably represents hydrogen, C₁-C₄-alkyl, halogen, C₁-C₄-alkoxy or C₁-C₂-haloalkyl,
Z preferably represents C₁-C₄-alkyl, halogen or C₁-C₄-alkoxy,
n preferably represents 0 or 1,
A and B together with the carbon atom to which they are attached preferably represent a saturated 5- to 6-membered ring which is optionally substituted by C₁-C₄-alkyl or C₁-C₄-alkoxy,
G preferably represents hydrogen (a) or represents the groups

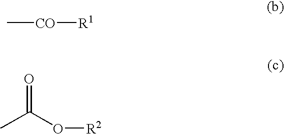

in which
R¹ represents in each case optionally halogen-substituted C₁-C₁₆-alkyl, C₂-C₁₆-alkenyl, C₁-C₆-alkoxy-C₂-C₆-alkyl or cycloalkyl having 3-7 ring atoms which may be interrupted by 1 to 2 oxygen and/or sulphur atoms, represents optionally halogen-, nitro-, C₁-C₄-alkyl-, C₁-C₄-alkoxy-, C₁-C₃-haloalkyl- or C₁-C₃-haloalkoxy-substituted phenyl,
R² represents in each case optionally halogen-substituted C₁-C₁₆-alkyl, C₂-C₁₆-alkenyl or C₁-C₆-alkoxy-C₂-C₆-alkyl,
   represents in each case optionally halogen-, nitro-, C₁-C₄-alkyl-, C₁-C₄-alkoxy- or C₁-C₄-haloalkyl-substituted phenyl or benzyl.

Particular preference is given to using active compound/beneficial species combinations comprising the dihydrofuranone derivative of the formula (I-b-1)

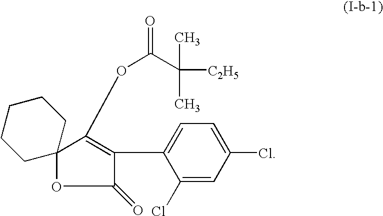

In addition, the active compound/beneficial species combinations may also comprise further suitable fungicidally, acaricidally or insecticidally active added components.

Preference is given to using beneficial species from the families of the Vespidae, Aphelinidae, Trichogrammatidae, Encyrtidae, Mymaridae, Eulophidae, Alloxystidae, Megaspilidae, Braconidae, Cantharidae, Coccinellidae, Cleridae, Chrysopidae, Hemerobiidae, Anthocoridae, Miridae, Forficulidae, Phytoseiidae, Carabidae, Staphylenidae, Ichneumonidae, Aphidiidae, Eumenidae, Sphecidae, Tachnidae, Syrphidae, Cecidomyiidae, Stigmaeidae, Angstidae, Trombidiidae, Nabidae, Pentatomidae, Reduviidae, Coniopterygidae, Chameiidae, Asilidae, soil mites, Phytoseidae in annual crops such as, for example, vegetables, melons, ornamental plants, maize, but also in perennial plants such as, for example, citrus fruit, pome fruit and stone fruit, spices, conifers and other ornamental plants, and also in afforestations.

The crops to be protected, which have only been described in a general manner, are described in a more differentiated and more specific manner below. Thus, with respect to the use, vegetable is to be understood as meaning, for example, fruit vegetables and flower-heads as vegetables, for example bell peppers, chilli peppers, tomatoes, aubergines, cucumbers, cucurbits, courgettes, broad beans, runner beans, bush beans, peas, artichokes;

but also leafy vegetables, for example lettuce, chicory, endives, cress, rocket salad, field salad, iceberg lettuce, leek, spinach, Swiss chard;

furthermore tuber vegetables, root vegetables and stem vegetables, for example celeriac, beetroot, carrots, garden radish, horseradish, scorzonera, asparagus, table beet, palm shoots, bamboo shoots, moreover bulb vegetables, for example onions, leek, fennel, garlic;

furthermore brassica vegetables, such as cauliflowers, broccoli, kohlrabi, red cabbage, white cabbage, green cabbage, Savoy cabbage, Brussels sprouts, Chinese cabbage.

With respect to the use, perennial crops are to be understood as meaning citrus fruit, such as, for example, oranges, grapefruit, mandarins, lemons, limes, bitter oranges, cumquats, satsumas;

but also pome fruit, such as, for example, apples, pears and quince, and stone fruit, such as, for example, peaches, nectarines, cherries, plums, common plums, apricots;

furthermore grapevine, hops, olives, tea, and tropical crops, such as, for example, mangoes, papayas, figs, pineapples, dates, bananas, durians, kakis, coconuts, cacao, coffee, avocados, lychees, maracujas, guavas,

moreover almonds and nuts, such as, for example, hazelnuts, walnuts, pistachios, cashew nuts, brazil nuts, pecan nuts, butter nuts, chestnuts, hickory nuts, macadamia nuts, peanuts,

additionally also soft fruit, such as, for example, blackcurrants, gooseberries, raspberries, blackberries, blueberries, strawberries, red bilberries, kiwis, cranberries.

With respect to the use, ornamental plants are to be understood as meaning annual and perennial plants, for example cut flowers, such as, for example, roses, carnations, gerbera, lilies, marguerites, chrysanthemums, tulips, daffodils, anemones, poppies, amaryllis, dahlias, azaleas, malves,

but also, for example, bedding plants, potted plants and shrubs, such as, for example, roses, tagetes, pansies, geraniums, fuchsias, hibiscus, chrysanthemums, busy lizzies, cyclamen, African violets, sunflowers, begonias,

furthermore, for example, bushes and conifers, such as, for example, fig trees, rhododendron, spruce trees, fir trees, pine trees, yew trees, juniper trees, stone pines, rose bays.

With respect to the use, spices are to be understood as meaning annual and perennial plants, such as, for example, aniseed, chilli pepper, bell pepper, pepper, vanilla, marjoram, thyme, cloves, juniper berries, cinnamon, tarragon, coriander, saffron, ginger.

From the family of Eumenidae, particular preference is given to: Eumenes spp., Oplomerus spp., in crops such as, for example, pome fruit, stone fruit, vegetables, ornamental plants, conifers and spices.

From the family of Sphecidae, particular preference is given to: Ammophila sabulos, Cerceris arenaria, in crops such as, for example, pome fruit, stone fruit, vegetables, ornamental plants, conifers and spices.

From the family of Vespidae, particular preference is given to: Polistes spp. Vespa spp., Dolichovespula spp., Vespula spp., Paravespula spp., in crops such as, for example, pome fruit, stone fruit, vegetables, ornamental plants, conifers and spices.

From the family of Aphelinidae, particular preference is given to: Coccophagus spp., Encarsia spp., for example, Encarsia formosa, Aphytis spp., Aphelinus spp., for example, Aphelinus mali, Aphelinus abdominalis, Erelmocerus spp., for example, Erelmocerus erimicus, Erelmocerus mundus, Prospaltella spp., in crops such as, for example, pome fruit, stone fruit, vegetables, ornamental plants, conifers and spices.

From the family of Trichogrammatidae, particular preference is given to: Trichogramma spp., for example, Trichogamma brassicae, in crops such as, for example, pome fruit, stone fruit, vegetables, ornamental plants, conifers and spices.

From the family of Encyrtidae, particular preference is given to: Encyrtus fuscicollis, Aphidencyrtrus spp., in crops such as, for example, pome fruit, stone fruit, vegetables, ornamental plants, conifers, spices and afforestations.

From the family of Mymaridae, in crops such as, for example, pome fruit, stone fruit, vegetables, ornamental plants, conifers and spices.

From the family of Ichneumoidae, particular preference is given to: Coccigomymus spp. Diadegma spp., Glypta spp., Ophion spp., Pimpla spp,. in crops such as, for example, pome fruit, stone fruit, vegetables, ornamental plants, conifers and spices.

From the family of Eulophidae, particular preference is given to: Dyglyphus spp., for example, Dyglyphus isaea, Eulophus viridula, Colpoclypeus florus, in crops such as, for example, pome fruit, stone fruit, vegetables, ornamental plants, conifers, maize and spices.

From the family of Alloxystidae, particular preference is given to: Alloxysta spp., in crops such as, for example, pome fruit, stone fruit, vegetables, ornamental plants, conifers and spices.

From the family of Megaspilidae, particular preference is given to: Dendrocerus spp., in crops such as, for example, pome fruit, stone fruit, vegetables, ornamental plants, conifers and spices.

From the family of Bracconidae, particular preference is given to: Aphidrus spp., Praon spp., Opius spp., Dacnusa spp., for example, Dacnusa sibiria, Apanteles spp., Ascogaster spp., Macrocentrus spp., in crops such as, for example, pome fruit, stone fruit, vegetables, ornamental plants, conifers and spices.

From the family of Aphidiidae, particular preference is given to: Aphidius spp., for example, Aphidius colemani, Aphidius ervi, Diaeretiella spp., Lysiphlebus spp., in crops such as, for example, pome fruit, stone fruit, vegetables, ornamental plants, conifers and spices.

From the family of Coccinellidae, particular preference is given to: Harmonia spp., Coccinella spp., for example, Coccinella septempunctata, Adalia spp., for example, Adalia bipunctata, Calvia spp., Chilocorus spp., for example, Chilocorus bipustulatus, Scymnus spp., Cryptolaemus montrouzieri, Exochomus spp., Stethorus spp., for example, Scymnus abietes, Scymnus interruptus, Anatis spp., Rhizobius spp., Thea spp., in crops such as, for example, pome fruit, stone fruit, vegetables, ornamental plants, conifers and spices.

From the family of Staphylemidae, particular preference is given to: Aleochara spp., Aligota spp., Philonthus spp., Staphylinus spp., in crops such as, for example, pome fruit, stone fruit, vegetables, ornamental plants, conifers and spices.

From the family of Chrysopidae, particular preference is given to: Chrysopa spp., for example, Chrysopa oculata, Chrysopa perla, Chrysopa carnea, Chrysopa flava, Chrysopa septempunctata, Chrysoperla spp., Chrysopidia spp., for example, Chrysopidia ciliata, Hypochrysa spp., for example, Hypochrysa elegans, in crops such as, for example, pome fruit, stone fruit, vegetables, ornamental plants, conifers and spices.

From the family of Hemerobiidae, particular preference is given to: Hemerobius spp., for example, Hemerobius fenestratus, Hemerobius humulinus, Hemerobius micans, Hemerobius nitidulus, Hemerobius pini, Wesmaelius spp., for example, Wesmaelius nervosus, in crops such as, for example, pome fruit, stone fruit, vegetables, ornamental plants, conifers and spices.

From the family of Anthocoridae, particular preference is given to: Anthocoris spp., for example, Anthocoris nemoralis, Anthocoris nemorum, Orius spp., for example, Orius majusculus, Orius minutus, Orius laevigatus, Orius insidiosus, Orius niger, Orius vicinus, in crops such as, for example, pome fruit, stone fruit, vegetables, ornamental plants, conifers and spices.

From the family of Miridae, particular preference is given to: Atractotomus spp., for example, Atractotomus mali, Blepharidopterus spp., for example, Blepharidopterus angulatus, Camylomma spp., for example, Camylomma verbasci, Deraeocoris spp., Macrolophus spp., for example, Macrolophus caliginosus, in crops such as, for example, pome fruit, stone fruit, vegetables, ornamental plants, conifers and spices.

From the family of Pentatomidae, particular preference is given to: Arma spp., Podisus spp., for example, Podisus maculiventris, in crops such as, for example, pome fruit, stone fruit, vegetables, ornamental plants, conifers and spices.

From the family of Nabidae, particular preference is given to: Nabis spp., for example, Nabis apterus, in crops such as, for example, pome fruit, stone fruit, vegetables, ornamental plants, conifers and spices.

From the family of Reduviidae, particular preference is given to: Empicornis vagabundus, Reduvius personatus, Rhinocoris spp., in crops such as, for example, pome fruit, stone fruit, vegetables, ornamental plants, conifers and spices.

From the family of Tachinidae, particular preference is given to: Bessa fugax, Cyzenius albicans, Compsileura concinnata, Elodia tragica, Exorista larvarum, Lyphia dubia, in crops such as, for example, pome fruit, stone fruit, vegetables, ornamental plants, conifers and spices.

From the family of Syrphidae, particular preference is given to: Dasysyrphus spp., Episyrphus balteatus, Melangyna triangulata, Melanostoma spp., Metasyrphus spp., Platycheirus spp., Syrphus spp., in crops such as, for example, pome fruit, stone fruit, vegetables, ornamental plants, conifers and spices.

From the family of Cecidomyiidae, particular preference is given to: Aphidoletes aphidimyza, Feltiella acarisuga, in crops such as, for example, pome fruit, stone fruit, vegetables, ornamental plants, conifers and spices.

From the family of Phytoseidae, particular preference is given to: Amblyseius spp., Typhlodromus spp., Phytoseiulus spp., in crops such as pome fruit, stone fruit, vegetables, ornamental plants and spices.

The active compound/beneficial species combinations according to the invention are suitable for controlling animal pests, preferably arthropods and nematodes, in particular insects and/or arachnids, found in viticulture and the cultivation of fruit, in agriculture and horticulture and in afforestations. They are active against normally sensitive and resistant species, and against all or individual developmental stages. The abovementioned pests include:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linognathus spp., Trichodectes spp., Damalinia spp.

From the order of the Thysanoptera, for example, Hercinothrips femoralis, Thrips tabaci, Thrips palmi, Frankliniella occidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Cheimatobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

The active compound combinations can be converted into the customary formulations such as solutions, emulsions, wettable powders, suspensions, powders, dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is, emulsifiers and/or dispersants, and/or foam formers.

If the extender used is water, it is also possible, for example, to use organic solvents as cosolvents. The following are essentially suitable as liquid solvents: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Suitable solid carriers are:

for example ammonium salts and ground natural minerals such as kaolins, clays, talc, chalk, quartz, attapulgite, montmorillonite or diatomaceous earth, and ground synthetic minerals such as highly disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam formers are: for example nonionic and anionic emulsifiers such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates; suitable dispersants are: for example lignosulfite waste liquors and methylcellulose.

Tackifiers such as carboxymethylcellulose and natural and synthetic polymers in the form of powders, granules or lattices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95% by weight of active compound, preferably between 0.5 and 90%.

The active compound combination according to the invention can be present in commercially available formulations and in the use forms, prepared from these formulations, as a mixture with other active compounds, such as insecticides, attractants, sterilants, bactericides, acaricides, nematicides, fungicides, growth-regulating substances or herbicides. The insecticides include, for example, phosphates, carbamates, carboxylates, chlorinated hydrocarbons, phenylureas and substances produced by microorganisms, inter alia.

Mixtures with other known active compounds such as herbicides or with fertilizers and growth regulators are also possible.

When used as insecticides, the active compound combinations according to the invention can furthermore be present in their commercially available formulations and in the use forms, prepared from these formulations, as a mixture with synergists. Synergists are compounds which increase the action of the active compounds, without it being necessary for the synergist added to be active itself.

The active compound content of the use forms prepared from the commercially available formulations can vary within wide limits. The active compound concentration of the use forms can be from 0.0000001 to 95% by weight of active compound, preferably between 0.0001 and 1% by weight.

The compounds are employed in a customary manner appropriate for the use forms.

The active compound combinations can be used as such, in the form of concentrates or generally customary formulations such as powders, granules, solutions, suspensions, emulsions or pastes.

The abovementioned formulation can be prepared in a manner known per se, for example by mixing the active compounds with at least one solvent or diluent, emulsifier, dispersant and/or binder or fixative, water repellant, if desired desiccants and UV stabilizers, and if desired colorants and pigments and other processing auxiliaries.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment according to the invention of the plants and parts of plants with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts”, “parts of plants” and “plant parts” have been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferred and to be treated according to the invention include all plants which, in the genetic modification, received genetic material which imparts particularly advantageous useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are the increased defence of the plants against insects by toxins formed in the plants, in particular those formed by the genetic material from Bacillus Thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes in question which impart the desired traits can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these or still-to-be-developed genetic traits, which plant cultivars will be developed and/or marketed in the future.

The plants listed can be treated according to the invention in a particularly advantageous manner with the active compound/beneficial species combinations according to the invention. The preferred ranges stated above for the combinations also apply to the treatment of these plants. Particular emphasis is given to the treatment of plants with the active compound/beneficial species combinations specifically mentioned in the present text.

The good insecticidal and acaricidal action of the active compound/beneficial species combinations according to the invention can be seen from the examples which follow. While the individual active compounds show weaknesses in their action, the active compound/beneficial species combinations show an action which exceeds a simple active compound action.

### USE EXAMPLES

### Example A

In 4 replications, in each case five about 10-year-old apple trees (crown height about 2.5 m) of the cultivar “Braeburn” are treated against the red spider Panonychus ulmi (PANOUL). Here, the active compound (I-b-1) (240SC) and the commercial standard etoxazole (110 SC) are applied at the stated application rates in the presence of the predatory mite Amblyseius andersoni (AMBLAN) using a pressure-operated knapsack spray. The water application rate is 400 l/ha. Two applications are carried out at an interval of 42 days.

Evaluation is carried out 4 days prior to and 6, 29, 43 and 63 days after the 1st treatment by counting the number of adult spider mites and predatory mites on 25 leaves and establishing a prey/predator ratio as a measure for the supporting action of the beneficial species.

| Application | PANOUL | | | | |
|---|---|---|---|---|---|
| rate % | −4 d | 6 d | 29 d | 43 d | 63 d |
| etoxazole | 25 | 10 | 221 | 203 | 87 |
| 0.05% | | | | | |
| I-1-b | 36 | 13 | 111 | 52 | 0 |
| 0.04% | | | | | |
| untreated | 39 | 39 | 411 | 288 | 3 |

| Application | AMBLAN | | | | |
|---|---|---|---|---|---|
| rate % | −4 d | 6 d | 29 d | 43 d | 63 d |
| etoxazole | 1 | 5 | 18 | 52 | 86 |
| 0.05% | | | | | |
| I-1-b | 2 | 3 | 57 | 100 | 62 |
| 0.04% | | | | | |
| untreated | 4 | 7 | 97 | 229 | 85 |

| Application | Prey/Predator | | | | |
|---|---|---|---|---|---|
| rate % | −4 d | 6 d | 29 d | 43 d | 63 d |
| etoxazole | 25 | 2.0 | 12.3 | 3.9 | 1.01 |
| 0.05% | | | | | |
| I-1-b | 18 | 4.3 | 1.9 | 0.5 | 0.00 |
| 0.04% | | | | | |
| untreated | 9.75 | 5.6 | 4.2 | 1.3 | 0.04 |

Formula for the Calculation of the Kill Rate of a Combination of Two Active Compounds

The expected activity for a given combination of two active compounds can be calculated (cf. Colby, S. R.; “Calculating Synergistic and Antagonistic Responses of Herbicide Combinations”, Weeds 15, pages 20-22, 1967) as follows:

If
X is the kill rate, expressed in % of the untreated control, when employing active compound A at an application rate of in ppm or g/ha,
Y is the kill rate, expressed in % of the untreated control, when employing active compound B at an application rate of n ppm or g/ha,
E is the kill rate, expressed in % of the untreated control, when employing active compounds A and B at application rates of m and n ppm or g/ha,
then

$$E = X + Y - \frac{X \times Y}{100}$$

If the actual insecticidal kill rate is higher than the calculated one, the kill rates of the combination are superadditive, i.e. a synergistic effect is present. In this case, the kill rate that is actually observed has to be higher than the value, calculated using the formula above, for the expected kill rate (E).

### Example B

Panonychus ulmi Test

| | |
|---|---|
| Solvent: | 7 parts by weight of dimethylformamide |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration.

Plum cuttings (Prunus domestica) infested by the fruit tree spider mite (Panonychus ulmi) are treated on the upper side of the leaves by spraying with the preparation of active compound at the desired concentration.

After the desired period of time, a defined amount of predatory mites (Typhlodromus pyri) is added.

After the desired period of time, the kill of the pest in % is determined. 100% means that all spider mites have been killed; 0% means that none of the spider mites have been killed. The determined kill ratios are entered into Colby's formula.

In this test, for example, the following active compound/predatory mite combination according to the present application shows a synergistically enhanced activity compared to the components applied individually:

TABLE B
Plant-damaging insects
Panonychus ulmi - test

| | Concentration | | |
|---|---|---|---|
| | in ppm or | Kill in % | |
| Active compound | number of animals | after 7^{d} | |
| spirodiclofen (Ex. I-b-1) | 20 | 70 | |
| Typhlodromus pyri | About 50-100 eggs | 50 | |
| | | found* | calc.** |
| spirodiclofen + | 20 + 50-100 eggs | 99 | 85 |
| Typhlodromus pyri | | | |
| according to the invention | | | |

*found = activity found
**calc. = activity calculated using Colby's formula

### Example C

Critical Concentration Test/Soil Insects—Treatment of Transgenic Plants

| | |
|---|---|
| Test insect: | Diabrotica balteata - larvae in soil |
| Solvent: | 7 parts by weight of acetone |
| Emulsifier: | 1 part by weight of alkylaryl polyglycol ether |

To produce a suitable preparation of active compound, 1 part by weight of active compound is mixed with the stated amount of solvent, the stated amount of emulsifier is added and the concentrate is diluted with water to the desired concentration.

The preparation of active compound is poured onto the soil. Here, the concentration of active compound in the preparation is virtually immaterial; only the amount by weight of active compound per volume unit of soil, which is stated in ppm (mg/l), matters. The soil is filled into 0.25 l pots, and these are allowed to stand at 20° C.

Immediately after the preparation, 5 pregerminated maize corns of the cultivar YIELD GUARD (trade mark of Monsanto Comp., USA) are placed into each pot. After 2 days, the appropriate test insects are placed into the treated soil. After a further 7 days, the efficacy of the active compound is determined by counting the maize plants that have emerged (1 plant=20% activity).

### Example D

Heliothis virescens Test—Treatment of Transgenic Plants

| | |
|---|---|
| Solvent: | 7 parts by weight of acetone |
| Emulsifier: | 1 part by weight of alkylaryl polyglycol ether |

To produce a suitable preparation of active compound, 1 part by weight of active compound is mixed with the stated amount of solvent and the stated amount of emulsifier, and the concentrate is diluted with water to the desired concentration.

Soya bean shoots (Glycine max) of the cultivar Roundup Ready (trade mark of Monsanto Comp., USA) are treated by being dipped into the preparation of active compound of the desired concentration and are populated with the tobacco bud worm Heliothis virescens while the leaves are still moist.

After the desired period of time, the kill of the insects is determined.

1. Active compound/beneficial species combinations comprising compounds of the formula (I) 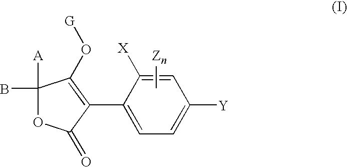
in which
X represents C₁-C₆-alkyl, halogen, C₁-C₆-alkoxy or C₁-C₃-haloalkyl,
Y represents hydrogen, C₁-C₆-alkyl, halogen, C₁-C₆-alkoxy or C₁-C₃-haloalkyl,
Z represents C₁-C₆-alkyl, halogen or C₁-C₆-alkoxy,
n represents a number 0-3,
A represents hydrogen or in each case optionally halogen-substituted straight-chain or branched C₁-C₁₂-alkyl, C₃-C₈-alkenyl, C₃-C₈-alkynyl, C₁-C₁₀-alkoxy-C₂-C₈-alkyl, C₁-C₈-polyalkoxy-C₂-C₈-alkyl, C₁-C₁₀-alkylthio-C₂-C₈-alkyl or cycloalkyl having 3-8 ring atoms which may be interrupted by oxygen and/or sulphur and in each case optionally halogen-, C₁-C₆-alkyl-, C₁-C₆-haloalkyl-, C₁-C₆-alkoxy-, C₁-C₆-haloalkoxy- or nitro-substituted phenyl or phenyl-C₁-C₆-alkyl,
B represents hydrogen, C₁-C₆-alkyl or C₁-C₆-alkoxy-C₂-C₄-alkyl
or in which
A and B together with the carbon atom to which they are attached form a saturated or unsaturated 3- to 8-membered ring which is optionally interrupted by oxygen and/or sulphur and optionally substituted by halogen, C₁-C₆-alkyl, C₁-C₆-alkoxy, C₁-C₄-haloalkyl, C₁-C₄-haloalkoxy, C₁-C₄-alkylthio or optionally substituted phenyl or is optionally benzo-fused,
G represents hydrogen (a) or represents the groups 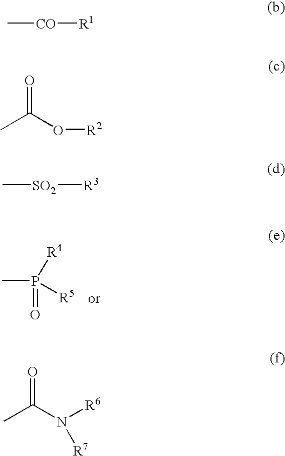
in which
R¹ represents in each case optionally halogen-substituted C₁-C₂₀-alkyl, C₂-C₂₀-alkenyl, C₁-C₈-alkoxy-C₂-C₈-alkyl, C₁-C₈-alkylthio-C₂-C₈-alkyl, C₁-C₈-polyalkoxy-C₂-C₈-alkyl or cycloalkyl having 3-8 ring atoms which may be interrupted by oxygen and/or sulphur atoms,
represents optionally halogen-, nitro-, C₁-C₆-alkyl-, C₁-C₆-alkoxy-, C₁-C₆-haloalkyl- or C₁-C₆-haloalkoxy-substituted phenyl,
represents optionally halogen-, C₁-C₆-alkyl-, C₁-C₆-alkoxy-, C₁-C₆-haloalkyl- or C₁-C₆-haloalkoxy-substituted phenyl-C₁-C₆-alkyl,
represents in each case optionally halogen- and/or C₁-C₆-alkyl-substituted pyridyl, pyrimidyl, thiazolyl or pyrazolyl,
represents optionally halogen- and/or C₁-C₆-alkyl-substituted phenoxy-C₁-C₆-alkyl,
R² represents in each case optionally halogen-substituted C₁-C₂₀-alkyl, C₂-C₂₀-alkenyl, C₁-C₈-alkoxy-C₂-C₈-alkyl or C₁-C₈-polyalkoxy-C₂-C₈-alkyl,
represents in each case optionally halogen-, nitro-, C₁-C₆-alkyl-, C₁-C₆-alkoxy- or C₁-C₆-haloalkyl-substituted phenyl or benzyl,
R³ represents optionally halogen-substituted C₁-C₈-alkyl, represents in each case optionally C₁-C₄-alkyl-, halogen-, C₁-C₄-haloalkyl-, C₁-C₄-alkoxy-, C₁-C₄-haloalkoxy-, nitro- or cyano-substituted phenyl or benzyl,
R⁴ and R⁵ independently of one another represent in each case optionally halogen-substituted C₁-C₈-alkyl, C₁-C₈-alkoxy, C₁-C₈-alkylamino, di-(C₁-C₈)-alkylamino, C₁-C₈-alkylthio, C₂-C₅-alkenylthio, C₂-C₅-alkynylthio or C₃-C₇-cycloalkylthio, represent in each case optionally halogen-, nitro-, cyano-, C₁-C₄-alkoxy-, C₁-C₄-haloalkoxy-, C₁-C₄-alkylthio-, C₁-C₄-haloalkylthio-, C₁-C₄-alkyl- or C₁-C₄-haloalkyl-substituted phenyl, phenoxy or phenylthio,
R⁶ and R⁷ independently of one another represent in each case optionally halogen-substituted C₁-C₁₀-alkyl, C₁-C₁₀-alkoxy, C₃-C₈-alkenyl or C₁-C₈-alkoxy-C₁-C₈-alkyl, represent optionally halogen-, C₁-C₆-haloalkyl-, C₁-C₆-alkyl- or C₁-C₆-alkoxy-substituted phenyl, represent optionally halogen-, C₁-C₆-alkyl-, C₁-C₆-haloalkyl- or C₁-C₆-alkoxy-substituted benzyl or together represent a 5- to 6-membered ring which is optionally interrupted by oxygen or sulphur and which may optionally be substituted by C₁-C₆-alkyl,
and beneficial species from the orders or sub-orders of the Araneae, Acari, Hymenoptera, Coleoptera, Neuroptera, Tysanoptera, Heteroptera, Diptera, Hemiptera, Dermaptera and/or Parasitiformes.

2. Active compound/beneficial species combinations according to claim 1 where the radicals of the compounds of the formula (I) are as defined below:
X represents C₁-C₄-alkyl, halogen, C₁-C₄-alkoxy or C₁-C₂-haloalkyl,
Y represents hydrogen, C₁-C₄-alkyl, halogen, C₁-C₄-alkoxy or C₁-C₂-haloalkyl,
Z represents C₁-C₄-alkyl, halogen or C₁-C₄-alkoxy,
n represents 0 or 1,
A and B together with the carbon atom to which they are attached represent a saturated 5- to 6-membered ring which is optionally substituted by C₁-C₄-alkyl or C₁-C₄-alkoxy,
G represents hydrogen (a) or represents the groups 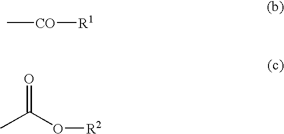
in which
R¹ represents in each case optionally halogen-substituted C₁-C₁₆-alkyl, C₂-C₁₆-alkenyl, C₁-C₆-alkoxy-C₂-C₆-alkyl or cycloalkyl having 3-7 ring atoms which may be interrupted by 1 to 2 oxygen and/or sulphur atoms,
represents optionally halogen-, nitro-, C₁-C₄-alkyl-, C₁-C₄-alkoxy-, C₁-C₃-haloalkyl- or C₁-C₃-haloalkoxy-substituted phenyl,
R² represents in each case optionally halogen-substituted C₁-C₁₆-alkyl, C₂-C₁₆-alkenyl or C₁-C₆-alkoxy-C₂-C₆-alkyl,
represents in each case optionally halogen-, nitro-, C₁-C₄-alkyl-, C₁-C₄-alkoxy- or C₁-C₄-haloalkyl-substituted phenyl or benzyl.

3. Active compound/beneficial species combinations according to claim 1 comprising the compound of the formula (I-b-1)

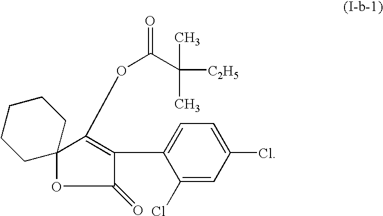

4. Use of active compound/beneficial species combinations as defined in claim 1 for controlling animal pests.

5. Method for controlling animal pests, characterized in that active compound/beneficial species combinations as defined in claim 1 are allowed to act on animal pests and/or their habitat.

6. Process for preparing insecticidal and/or acaricidal compositions, characterized in that active compound/beneficial species combinations as defined in claim 1 are mixed with extenders and/or surfactants.

7. Method for reducing spray applications (number of applications per season) by using active compound/beneficial species combinations according to claim 1.

8. Method for reducing the total insecticide and/or acaricide residues on the harvested material and in the environment by using active compound/beneficial species combinations according to claim 1.

9. Composition, comprising an active compound/beneficial species combination according to claim 1 for controlling animal pests.
